(19) United States
(12) Patent Application Publication
(10) Pub. No.: US 2026/0067831 A1
(43) Pub. Date: Mar. 5, 2026

(54) SYSTEMS AND METHODS FOR MAXIMUM POWER REDUCTION

(71) Applicant: Meta Platforms Technologies, LLC, Menlo Park, CA (US)

(72) Inventors: Zhu JI, Cupertino, CA (US); Suhwan LIM, Gyeonggi-Do (KR); Curt WONG, Bellevue, WA (US); Liwen YU, Santa Clara, CA (US)

(73) Assignee: Meta Platforms Technologies, LLC, Menlo Park, CA (US)

(21) Appl. No.: 19/293,188

(22) Filed: Aug. 7, 2025

Related U.S. Application Data
(60) Provisional application No. 63/690,720, filed on Sep. 4, 2024.

(51) Int. Cl. H04W 52/36; H04W 72/0453; H04W 88/06

(52) U.S. Cl. CPC H04W 52/367; H04W 72/0453; H04W 88/06

(57) ABSTRACT

A device may include one or more processors and a transmitter that performs an intra-band carrier aggregation (CA). The one or more processors may be configured to determine, as a first determination result, whether the CA is contiguous or non-contiguous. The one or more processors may be configured to identify, based at least on a power class of the device and the first determination result, an amount of maximum power reduction (MPR) of the device. The transmitter may be configured to transmit data using the identified amount of MPR of the device.

### CROSS-REFERENCE TO RELATED APPLICATION

This application claims priority to U.S. Provisional Patent Application No. 63/690,720 filed on September 4, 2024, which is incorporated by reference herein in its entirety for all purposes.

### FIELD OF DISCLOSURE

The present disclosure is generally related to wireless communication, including but not limited to operating devices based on maximum power reduction.

### BACKGROUND

Cellular communication technology (e.g., 3G, 4G, 5G) allows high data rate communication. In such an environment, a user equipment (UE) can generate and transmit data to a base station. A base station may provide or forward data from the UE onward to the destination. A base station can provide or forward data from another base station to another UE.

### SUMMARY

Various embodiments disclosed herein are related to a device. The device may include one or more processors and a transmitter that performs an intra-band carrier aggregation (CA). The one or more processors may be configured to determine, as a first determination result, whether the CA is contiguous or non-contiguous. The one or more processors may be configured to identify, based at least on a power class of the device and the first determination result, an amount of maximum power reduction (MPR) of the device. The transmitter may be configured to transmit data using the identified amount of MPR of the device.

Various embodiments disclosed herein are related to a method. The method may include performing, by a transmitter of a device, an intra-band carrier aggregation (CA). The method may include determining, by one or more processors of the device, as a first determination result, whether the CA is contiguous or non-contiguous. The method may include identifying, by the one or more processors, based at least on a power class of the device and the first determination result, an amount of maximum power reduction (MPR) of the device. The method may include transmitting, by the transmitter, data using the identified amount of MPR of the device.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram showing example components of a base station and a user equipment, according to an example implementation of the present disclosure.

FIG. 3 is an example of a device including a CA evaluator, an MPR identifier, and a transmitter, according to an example implementation of the present disclosure.

FIG. 4A illustrates an example of a circuit that can be included in the device of FIG. 3, according to an example implementation of the present disclosure.

FIG. 4B illustrates an example of a circuit that can be included in the device of FIG. 3, according to an example implementation of the present disclosure.

FIG. 5 illustrates an example of different maximum transmit power values, according to an example implementation of the present disclosure.

FIG. 6 illustrates an example of MPR values, according to an example implementation of the present disclosure.

FIG. 7 illustrates an example of MPR values, according to an example implementation of the present disclosure.

FIG. 8 is a flowchart showing a process for MPR, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Wireless communication systems continue to support increasing uplink performance demands, particularly in high-throughput scenarios such as 4K/8K video streaming, extended reality (XR), and large-scale file upload. These uplink-intensive applications may involve periodic or aperiodic bursts of data, generated by one or more applications or sensors on a user device. For instance, head-mounted XR devices or live-streaming cameras may transmit uplink data with frequent bursts aligned to content encoding intervals (e.g., 30 fps, 60 fps). Similarly, machine vision applications in mobile or edge-connected devices may stream image or sensor data at high frame rates for real-time inference. In some cases, the uplink data traffic may span multiple frequency bands or involve carrier aggregation across different components.

To support such use cases, high power uplink transmission, such as Power Class 1.5 (PC1.5) UE operation, has been introduced in 3GPP releases. A PC1.5 UE may support up to 29 dBm total output power using two power amplifiers (e.g., 2x25 dBm), enhancing coverage and performance for demanding uplink workloads. When combined with carrier aggregation (CA) or dual connectivity (DC), the uplink power envelope is managed to ensure regulatory compliance and hardware performance. These may vary depending on whether CA is intra-band or inter-band, contiguous or non-contiguous, or if dual transmit chains (2Tx or 3Tx) are involved.

Power-limiting mechanisms such as maximum power reduction (MPR) or additional MPR (A-MPR) may be used to meet spectrum emission limits and spurious emission specifications. Meanwhile, power exposure constraints, such as specific absorption rate (SAR) or maximum permissible exposure (MPE), are imposed by regional regulations to protect human health. These may require the UE to further reduce average transmission power by applying additional techniques such as periodic uplink duty cycling. Such considerations become more complex when dual PA architectures, antenna configurations, or multi-band CA/DC features are involved. Accordingly, enhancements in UE RF architecture, MPR handling, and power class specification are needed to support high power CA/DC UE operation across various regulatory and deployment conditions.

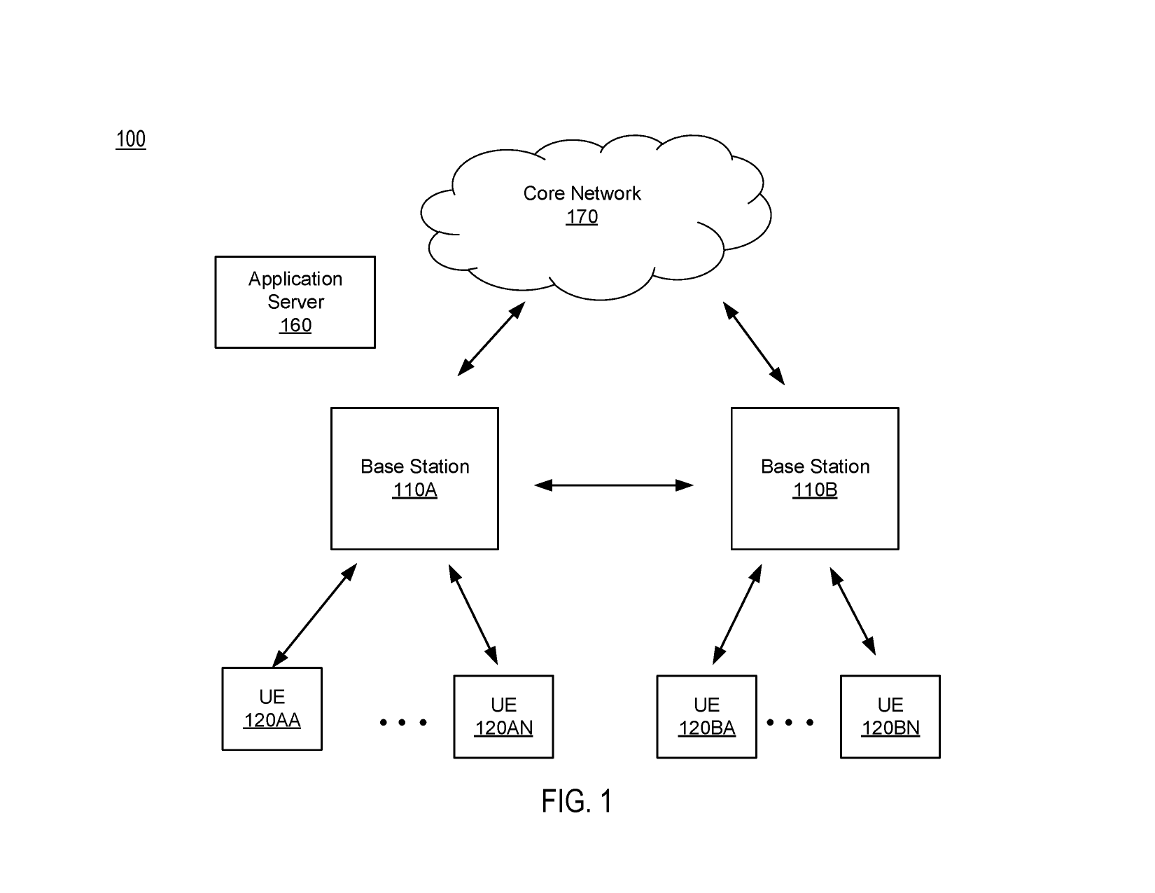

FIG. 1 illustrates an example wireless communication system 100. The wireless communication system 100 may include base stations 110A, 110B (also referred to as “wireless communication nodes 110” or “stations 110”) and user equipments (UEs) 120AA…120AN, 120BA…120BN (also referred to as “wireless communication devices 120” or “terminal devices 120”). The wireless communication link may be a cellular communication link conforming to 3G, 4G, 5G, 6G or other cellular communication protocols. In one example, the wireless communication link supports, employs or is based on an orthogonal frequency division multiple access (OFDMA). In one aspect, the UEs 120AA…120AN are located within a geographical boundary with respect to the base station 110A, and may communicate with or through the base station 110A. Similarly, the UEs 120BA…120BN are located within a geographical boundary with respect to the base station 110B, and may communicate with or through the base station 110B. A network between UEs 120 and the base stations 110 may be referred to as radio access network (RAN). In some embodiments, the wireless communication system 100 includes more, fewer, or different number of base stations 110 than shown in FIG. 1.

In some embodiments, the UE 120 may be a user device such as a mobile phone, a smart phone, a personal digital assistant (PDA), tablet, laptop computer, wearable computing device (e.g., head mounted display, smart watch), etc. Each UE 120 may communicate with the base station 110 through a corresponding communication link. For example, the UE 120 may transmit data to a base station 110 through a wireless communication link (e.g., 3G, 4G, 5G, 6G or other cellular communication link), and/or receive data from the base station 110 through the wireless communication link (e.g., 3G, 4G, 5G, 6G or other cellular communication link). Example data may include audio data, image data, text, etc. Communication or transmission of data by the UE 120 to the base station 110 may be referred to as an uplink communication. Communication or reception of data by the UE 120 from the base station 110 may be referred to as a downlink communication.

In some embodiments, the base station 110 may be an evolved node B (eNB), a gNodeB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations.

In some embodiments, the wireless communication system 100 includes a core network 170. The core network 170 may be a component or an aggregation of multiple components that ensures reliable and secure connectivity to the network for UEs 120. The core network 170 may be communicatively coupled to one or more base stations 110A, 110B through a communication link. A communication link between the core network 170 and a base station 110 may be a wireless communication link (e.g., 3G, 4G, 5G, 6G or other cellular communication link) or a wired communication link (e.g., Ethernet, optical communication link, etc.). In some embodiments, the core network 170 includes user plane function (UPF), access and mobility management function (AMF), policy control function (PCF), etc. The UPF may perform packet routing and forwarding, packet inspection, quality of service (QoS) handling, and provide external protocol data unit (PDU) session for interconnecting data network (DN). The AMF may perform registration management, reachability management, connection management, etc. The PCF may help operators (or operating devices) to easily create and seamlessly deploy policies in a wireless network. The core network 170 may include additional components for managing or controlling operations of the wireless network. In one aspect, the core network 170 may receive a message to perform a network congestion control, and perform the requested network congestion control. For example, the core network 170 may receive explicit congestion notification (ECN) from a base station 110 and/or a UE 120, and perform a network congestion control according to the ECN. For example, the core network 170 may adjust or control an amount of data generated, in response to the ECN. Additionally or alternatively, the core network 170 may adjust or control an amount of data transmitted and/or received, in response to the ECN.

In some embodiments, the wireless communication system 100 includes an application server 160. The application server 160 may be a component or a device that generates, manages, or provides content data. The application server 160 may be communicatively coupled to one or more base stations 110A, 110B through a communication link. A communication link between an application server 160 and a base station 110 may be a wireless communication link (e.g., 3G, 4G, 5G, 6G or other cellular communication link) or a wired communication link (e.g., Ethernet, optical communication link, etc.). In one aspect, an application server 160 may receive a request for data from a UE 120 through a base station 110, and provide the requested data to the UE 120 through the base station 110. In one aspect, an application server 160 may receive a message to perform a network congestion control, and perform the requested network congestion control. For example, the application server 160 may receive explicit congestion notification (ECN) from a base station 110, a UE 120, or a core network 170, and perform a network congestion control according to the ECN. For example, the application server 160 may adjust or control an amount of data generated, in response to the ECN. Additionally or alternatively, the application server 160 may adjust or control an amount of data transmitted and/or received, in response to the ECN. Additionally or alternatively, the application server 160 may adaptively adjust or control an error correct rate. An error correction rate may be a rate of a number of error correction packets (also referred to as “protection packets”) per a set of packets for transmission. An error correction packet can be provided to help recover content. The application server 160 may adaptively adjust the error correction rate, according to a signal quality of a signal received by a UE 120 or a location of the UE 120 with respect to one or more base stations 110.

In some embodiments, communication among the base stations 110, the UEs 120, application server 160, and the core network 170 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

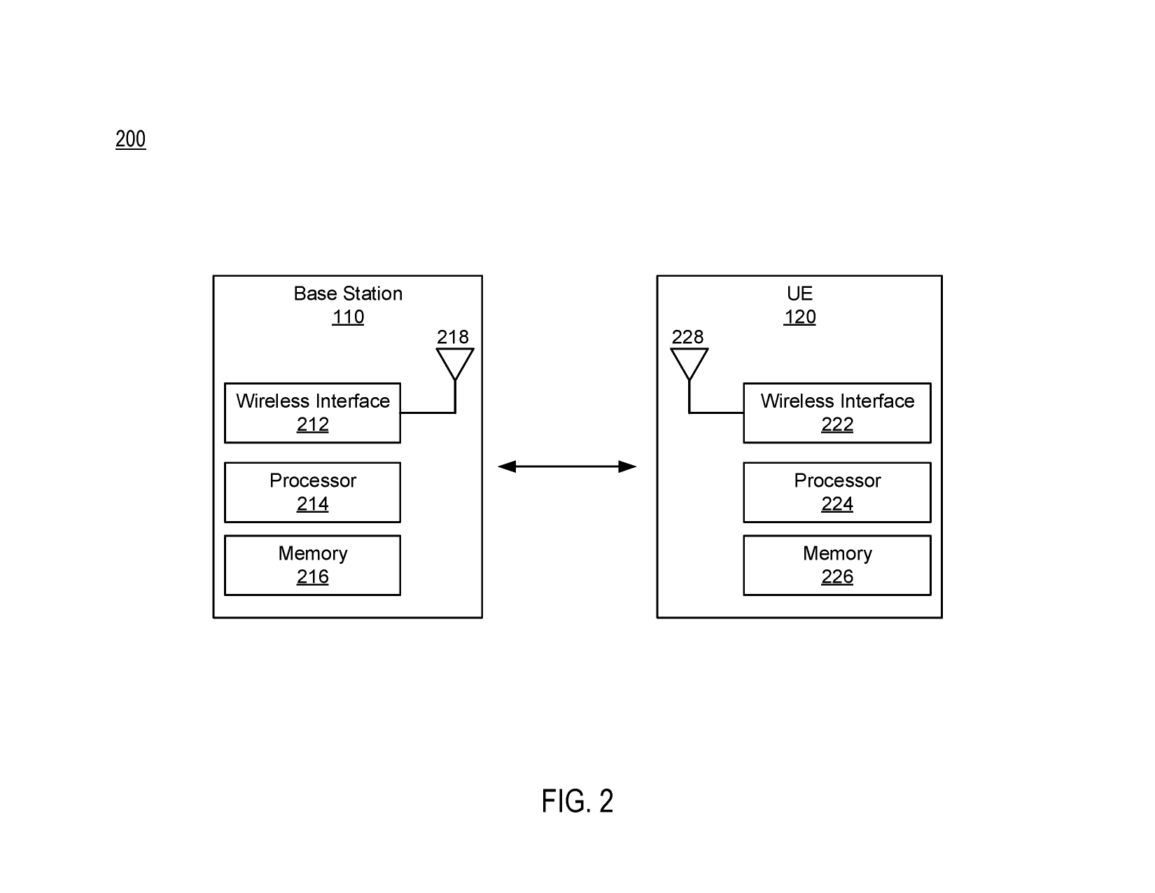

FIG. 2 is a diagram showing example components of a base station 110 and a user equipment 120, according to an example implementation of the present disclosure. In some embodiments, the UE 120 includes a wireless interface 222, a processor 224, a memory device 226, and one or more antennas 228. These components may be embodied as hardware, software, firmware, or a combination thereof. In some embodiments, the UE 120 includes more, fewer, or different components than shown in FIG. 2. For example, the UE 120 may include an electronic display and/or an input device. For example, the UE 120 may include additional antennas 228 and wireless interfaces 222 than shown in FIG. 2.

The antenna 228 may be a component that receives a radio frequency (RF) signal and/or transmits a RF signal through a wireless medium. The RF signal may be at a frequency between 200 MHz to 100 GHz. The RF signal may have packets, symbols, or frames corresponding to data for communication. The antenna 228 may be a dipole antenna, a patch antenna, a ring antenna, or any suitable antenna for wireless communication. In one aspect, a single antenna 228 is utilized for both transmitting a RF signal and receiving a RF signal. In one aspect, different antennas 228 are utilized for transmitting the RF signal and receiving the RF signal. In one aspect, multiple antennas 228 are utilized to support multiple-in, multiple-out (MIMO) communication.

The wireless interface 222 includes or is embodied as a transceiver for transmitting and receiving RF signals through one or more antennas 228. The wireless interface 222 may communicate with a wireless interface 212 of the base station 110 through a wireless communication link. In one configuration, the wireless interface 222 is coupled to one or more antennas 228. In one aspect, the wireless interface 222 may receive the RF signal at the RF frequency received through an antenna 228, and downconvert the RF signal to a baseband frequency (e.g., 0~1 GHz). The wireless interface 222 may provide the downconverted signal to the processor 224. In one aspect, the wireless interface 222 may receive a baseband signal for transmission at a baseband frequency from the processor 224, and upconvert the baseband signal to generate a RF signal. The wireless interface 222 may transmit the RF signal through the antenna 228.

The processor 224 is a component that processes data. The processor 224 may be embodied as field programmable gate array (FPGA), application specific integrated circuit (ASIC), a logic circuit, etc. The processor 224 may obtain instructions from the memory device 226, and execute the instructions. In one aspect, the processor 224 may receive downconverted data at the baseband frequency from the wireless interface 222, and decode or process the downconverted data. For example, the processor 224 may generate audio data or image data according to the downconverted data, and present an audio indicated by the audio data and/or an image indicated by the image data to a user of the UE 120. In one aspect, the processor 224 may generate or obtain data for transmission at the baseband frequency, and encode or process the data. For example, the processor 224 may encode or process image data or audio data at the baseband frequency, and provide the encoded or processed data to the wireless interface 222 for transmission.

The memory device 226 is a component that stores data. The memory device 226 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 226 may be embodied as a non-transitory computer readable medium storing instructions executable by the processor 224 to perform various functions of the UE 120 disclosed herein. In some embodiments, the memory device 226 and the processor 224 are integrated as a single component.

In some embodiments, the base station 110 includes a wireless interface 212, a processor 214, a memory device 216, and one or more antennas 218. These components may be embodied as hardware, software, firmware, or a combination thereof. In some embodiments, the base station 110 includes more, fewer, or different components than shown in FIG. 2. For example, the base station 110 may include an electronic display and/or an input device. For example, the base station 110 may include additional antennas 218 and wireless interfaces 212 than shown in FIG. 2.

The antenna 218 may be a component that receives a radio frequency (RF) signal and/or transmits a RF signal through a wireless medium. The antenna 218 may be a dipole antenna, a patch antenna, a ring antenna, or any suitable antenna for wireless communication. In one aspect, a single antenna 218 is utilized for both transmitting a RF signal and receiving a RF signal. In one aspect, different antennas 218 are utilized for transmitting the RF signal and receiving the RF signal. In one aspect, multiple antennas 218 are utilized to support multiple-in, multiple-out (MIMO) communication.

The wireless interface 212 includes or is embodied as a transceiver for transmitting and receiving RF signals through one or more antennas 218. The wireless interface 212 may communicate with a wireless interface 222 of the UE 120 through a wireless communication link. In one configuration, the wireless interface 212 is coupled to one or more antennas 218. In one aspect, the wireless interface 212 may receive the RF signal at the RF frequency received through antenna 218, and downconvert the RF signal to a baseband frequency (e.g., 0~1 GHz). The wireless interface 212 may provide the downconverted signal to the processor 214. In one aspect, the wireless interface 212 may receive a baseband signal for transmission at a baseband frequency from the processor 214, and upconvert the baseband signal to generate a RF signal. The wireless interface 212 may transmit the RF signal through the antenna 218.

The processor 214 is a component that processes data. The processor 214 may be embodied as FPGA, ASIC, a logic circuit, etc. The processor 214 may obtain instructions from the memory device 216, and execute the instructions. In one aspect, the processor 214 may receive downconverted data at the baseband frequency from the wireless interface 212, and decode or process the downconverted data. For example, the processor 214 may generate audio data or image data according to the downconverted data. In one aspect, the processor 214 may generate or obtain data for transmission at the baseband frequency, and encode or process the data. For example, the processor 214 may encode or process image data or audio data at the baseband frequency, and provide the encoded or processed data to the wireless interface 212 for transmission. In one aspect, the processor 214 may set, assign, schedule, or allocate communication resources for different UEs 120. For example, the processor 214 may set different modulation schemes, time slots, channels, frequency bands, etc. for UEs 120 to avoid interference. The processor 214 may generate data (or UL CGs) indicating configuration of communication resources, and provide the data (or UL CGs) to the wireless interface 212 for transmission to the UEs 120.

The memory device 216 is a component that stores data. The memory device 216 may be embodied as RAM, flash memory, ROM, EPROM, EEPROM, registers, a hard disk, a removable disk, a CD-ROM, or any device capable for storing data. The memory device 216 may be embodied as a non-transitory computer readable medium storing instructions executable by the processor 214 to perform various functions of the base station 110 disclosed herein. In some embodiments, the memory device 216 and the processor 214 are integrated as a single component.

In one aspect, it would be beneficial to enable high-power UE, such as Power Class 1.5 (PC1.5) UEs, to support uplink CA and DC modes in 5G NR systems. For example, a PC1.5 UE may transmit uplink data over two or more component carriers (CCs) within a single band (e.g., intra-band) using contiguous or non-contiguous allocation. However, some 3GPP specifications prior to Release 19 do not define the transmit RF characteristics, such as MPR, spurious emission limits, or SAR-compliant behavior, for such high-power configurations. This lack of definition prevents compliant operation of high-power CA/DC UEs under regulatory constraints (e.g., spurious emission and RF exposure limits), thereby limiting their deployment and performance.

To address these problems, the present disclosure includes systems, devices, and methods for enabling PC1.5 CA/DC UEs to operate with appropriate RF specifications. In some embodiments, a device (e.g., UE) can identify whether it operates under intra-band contiguous or non-contiguous CA, and determine a corresponding MPR value based on power class and regulatory emission requirements (e.g., –30 dBm/MHz or –13 dBm/MHz). In addition, when the determined MPR is not sufficient to meet SAR limits, the UE may apply additional measures such as power-dependent MPR (P-MPR) or maximum uplink duty cycle control. These techniques allow high-power UEs to comply with emission and exposure regulations across a variety of CA/DC configurations, while maintaining efficient data transmission in 5G networks.

In some embodiments, a device may be or include a user equipment (UE) such as a smartphone, a tablet, or other wireless communication devices. The device may include one or more processors (e.g., the processor 224) and a transmitter (e.g., the wireless interface 222). The one or more processors may perform signal processing, control logic, and power management for the device. The transmitter may be configured to send data via a wireless communication interface over a network (e.g., a cellular network). In particular, the transmitter may perform intra-band CA, where two or more component carriers (CCs) allocated within the same frequency band are aggregated to increase the uplink throughput. In some implementations, the device supports high-power uplink operation, such as Power Class 1.5, which allows for enhanced coverage and capacity in 5G New Radio (NR) systems. The processors and transmitter may operate in conjunction to support such intra-band CA operation, including both contiguous and non-contiguous allocations across the aggregated carriers.

In some embodiments, the device may be or include a UE, and the data may be transmitted to a base station. The base station may be a part of a radio access network that provides wireless connectivity between the UE and a core network. The transmitter of the UE may transmit various types of data, such as user traffic or control signaling, over an uplink connection established with the base station. The transmission may be carried out using one or more CCs aggregated through intra-band CA, and may be performed in accordance with the power class, MPR, and any additional constraints such as power-dependent MPR (P-MPR) and uplink duty cycle limitations, as determined by the processors.

In some implementations, the one or more processors may be configured to determine, as a first determination result, whether the CA is contiguous or non-contiguous. In some implementations, this determination may be performed by evaluating whether the aggregated CCs fall within a contiguous frequency range without any intervening gaps. If the CCs are positioned directly adjacent to one another within the same band, the CA may be considered contiguous. If the CCs are separated by one or more frequency gaps, the CA may be considered non-contiguous. This first determination result may serve as a basis for later operations, including identification of MPR values appropriate for the given CA configuration.

In some embodiments, the one or more processors may identify, based at least on a power class of the device and the determination of whether the intra-band CA is contiguous or non-contiguous, an amount of MPR. The power class may reflect a transmit power capability of the device, such as Power Class 1.5, which can correspond to higher uplink transmission power levels. By identifying the power class in combination with the CA configuration, the processors may determine an appropriate amount of MPR to reduce transmission power and meet system requirements, such as those related to signal linearity or emission control. The identified MPR value may be applied to one or more CCs associated with the aggregated uplink transmission. In this way, the MPR value may be selected to align with performance and regulatory limits based on the specific operating mode of the high-power UE.

In some embodiments, the power class of the device may correspond to a maximum transmit power level selected from a set of defined values. For instance, the device may operate according to Power Class 1.5, and the maximum transmit power of the device may be one of 27.8 dBm, 29 dBm, 30 dBm, or 30.8 dBm. These power levels may be defined for different frequency ranges or regional emission requirements and may reflect support for high-power uplink operation in 5G New Radio (NR) systems. The one or more processors may identify this power class as part of the logic for determining applicable power control and emission compliance mechanisms, including the selection of a corresponding MPR value appropriate for the power class of the device.

In some embodiments, in identifying the amount of MPR of the device, the one or more processors may determine whether the transmitter uses contiguous resource block (RB) allocation or non-contiguous RB allocation across the aggregated CCs. For instance, when the intra-band CA is determined to be contiguous, the RB allocation within the aggregated carriers may vary depending on how the frequency resources are assigned. The processors may determine, as a second determination result, whether the RB allocation pattern is contiguous or non-contiguous. Based on the power class of the device (e.g., Power Class 1.5), the first determination result (e.g., that the CA is contiguous), and the second determination result (e.g., the type of RB allocation), the processors may identify a corresponding amount of MPR to be applied. The MPR may be selected form a predefined set of values corresponding to different power classes and RB allocation patterns and may be used to satisfy transmission requirements such as emission compliance, power efficiency, and link robustness under the given CA configuration.

In some embodiments, in identifying the amount of MPR of the device, the one or more processors may identify the MPR based at least on a power class of the device, a first determination result, and an out-of-band (OOB) emission limit. For instance, when the first determination result indicates that the intra-band CA is non-contiguous, the processors may evaluate the spectral behavior of the aggregated uplink transmission. In particular, the processors may consider how emissions fall outside the assigned frequency band (e.g., OOB emissions). The device may reference a regulatory or system-defined OOB emission limit that is not to be exceeded. Based on this emission constraint, along with the power class of the device (e.g., Power Class 1.5 or others) and the determination that the CA is non-contiguous, the processors may select an appropriate MPR value that ensures compliance with the emission requirement. This identified MPR value may then be applied to limit the transmit power so that the emissions remain within allowed spectral boundaries.

In some embodiments, the OOB emission limit may be defined according to specific transmit spectral mask requirements for high-power uplink devices using intra-band non-contiguous CA with a dual power amplifier architecture. For example, the one or more processors may determine that the applicable OOB emission limit is –30 dBm/MHz and may identify a corresponding amount of MPR to ensure compliance with this limit. The processors may determine that the MPR is equal to a value selected based on the total occupied bandwidth (B) of the aggregated uplink carriers. For example, the value may be 17.0 dB when B is less than 1.44 MHz, 16.0 dB when B is between 1.44 MHz and 2.88 MHz, 14.5 dB when B is between 2.88 MHz and 5.76 MHz, 13.0 dB when B is between 5.76 MHz and 10.8 MHz, 11.5 dB when B is between 10.8 MHz and 23.04 MHz, 10.0 dB when B exceeds 23.04 MHz, etc. In another example, for a different emission limit, such as –13 dBm/MHz (e.g., for spurious emission scenarios), the processors may determine the MPR using an alternate MA profile, such as 10.5 dB when B is less than 0.54 MHz, 9.5 dB when B is between 0.54 MHz and 1.08 MHz, 8.0 dB when B is between 1.08 MHz and 2.16 MHz, 7.5 dB when B is between 2.16 MHz and 5.4 MHz, 6.5 dB when B is between 5.4 MHz and 10.8 MHz, 5.0 dB when B exceeds 10.8 MHz, etc. In each case, the processors may select the MPR value based on the bandwidth category, the applicable emission constraint, and the power class of the device, ensuring that transmission complies with emission limits under the given CA configuration.

In some embodiments, in identifying the amount of MPR of the device, the one or more processors may identify the MPR based at least on a power class of the device, a first determination result, and a spurious emission limit. For instance, when the first determination result indicates that the intra-band CA is non-contiguous, the processors may assess whether the uplink transmission produces unwanted emissions that fall outside the expected frequency bands but are not within the regulated OOB ranges (e.g., spurious emissions). In such cases, the processors may reference a spurious emission limit specified by regulatory guidelines or system requirements. The processors may then identify an MPR value that is sufficient to ensure that the transmission power remains within the allowed spurious emission thresholds. This MPR value may be determined based on the combination of the applicable power class (e.g., Power Class 1.5), the non-contiguous CA determination, and the relevant spurious emission limit.

In some embodiments, the transmitter may be configured to transmit data using the identified amount of MPR of the device. For example, based on the MPR value identified by the one or more processors, taking into account parameters such as power class, component CA configuration, and emission limits, the transmitter may reduce its output power accordingly. This adjustment can help ensure that the transmitted signal adheres to regulatory limits for emissions (e.g., OOB or spurious) while maintaining reliable uplink communication. The transmitter may apply this power setting when sending uplink data to a base station or other receiving device as part of normal operation in a wireless communication system.

In some embodiments, the one or more processors may identify a SAR limit applicable to the device. The SAR limit may represent a regulatory or design constraint on the amount of radio frequency (RF) energy absorbed by the user’s body during operation. Based on the identified SAR limit and the previously identified amount of MPR, the one or more processors may determine an amount of P-MPR of the device. The P-MPR may reflect an additional reduction in transmit power needed to ensure that the device remains compliant with SAR requirements under varying operating conditions. The transmitter may transmit second data using the determined amount of P-MPR, thereby maintaining both emission compliance and user exposure limits during uplink transmissions.

In some embodiments, the one or more processors may identify a maximum uplink duty cycle of the device based at least on the power class of the device. The maximum uplink duty cycle may correspond to a regulatory or implementation-defined limit on how frequently the device is permitted to transmit data within a given time interval. The processors may also identify a SAR limit and determine, based on both the SAR limit and the identified maximum uplink duty cycle, an adjusted maximum uplink duty cycle of the device. The adjusted value may ensure that the average transmit power over time satisfies SAR compliance under high-power operating conditions. The transmitter may be configured to transmit third data using the amount of P-MPR, the adjusted maximum uplink duty cycle, or a combination of the P-MPR and the adjusted maximum uplink duty cycle. This approach may enable adaptive transmission control while maintaining conformance with emission exposure limits.

In some embodiments, the one or more processors may determine that a maximum uplink duty cycle of the device does not meet a SAR limit. For instance, under certain transmission scenarios, such as prolonged high-power uplink operation, the cumulative uplink activity may exceed the allowed SAR exposure threshold. In response, the transmitter may be configured to transmit, to a base station, an indication of the amount of P-MPR of the device. This indication may allow the base station to coordinate or adjust network-side parameters accordingly, such as scheduling or power control, to maintain compliance with SAR constraints while sustaining communication performance.

In some embodiments, the device may perform a DC operation. In such an operation, the device may establish and maintain simultaneous connections with two distinct base stations or network nodes, such as a master node and a secondary node. These nodes may operate on different carrier frequencies or in different frequency bands. The DC operation can improve throughput, reduce latency, and enhance reliability by enabling data transmission and reception over both connections. The one or more processors may control coordination of data flow across the master and secondary links, while the transmitter may support scheduling, resource allocation, and power management for both links in accordance with the CA configuration and the applicable power class.

Embodiments in the present disclosure have at least the following advantages and benefits. Embodiments in the present disclosure can provide useful techniques for enabling uplink transmissions from high-power devices, such as Power Class 1.5 UE, while satisfying emission and regulatory constraints in various intra-band CA scenarios. By dynamically determining the amount of MPR based on aggregation type, power class, and applicable emission limits (e.g., OOB or spurious), these embodiments allow the device to adapt its transmit power effectively. Further embodiments in the present disclosure can support optional integration with SAR and duty cycle mitigation mechanisms, enabling flexible power control across a wide range of deployment and compliance conditions.

With the foregoing in mind, the figures and description below illustrate various examples of systems and/or methods for dynamically determining MPR and operating the device based thereon. It should be noted that the figures and description below are non-limiting examples and can be implemented as any of various other configurations while remaining within the scope of the present disclosure.

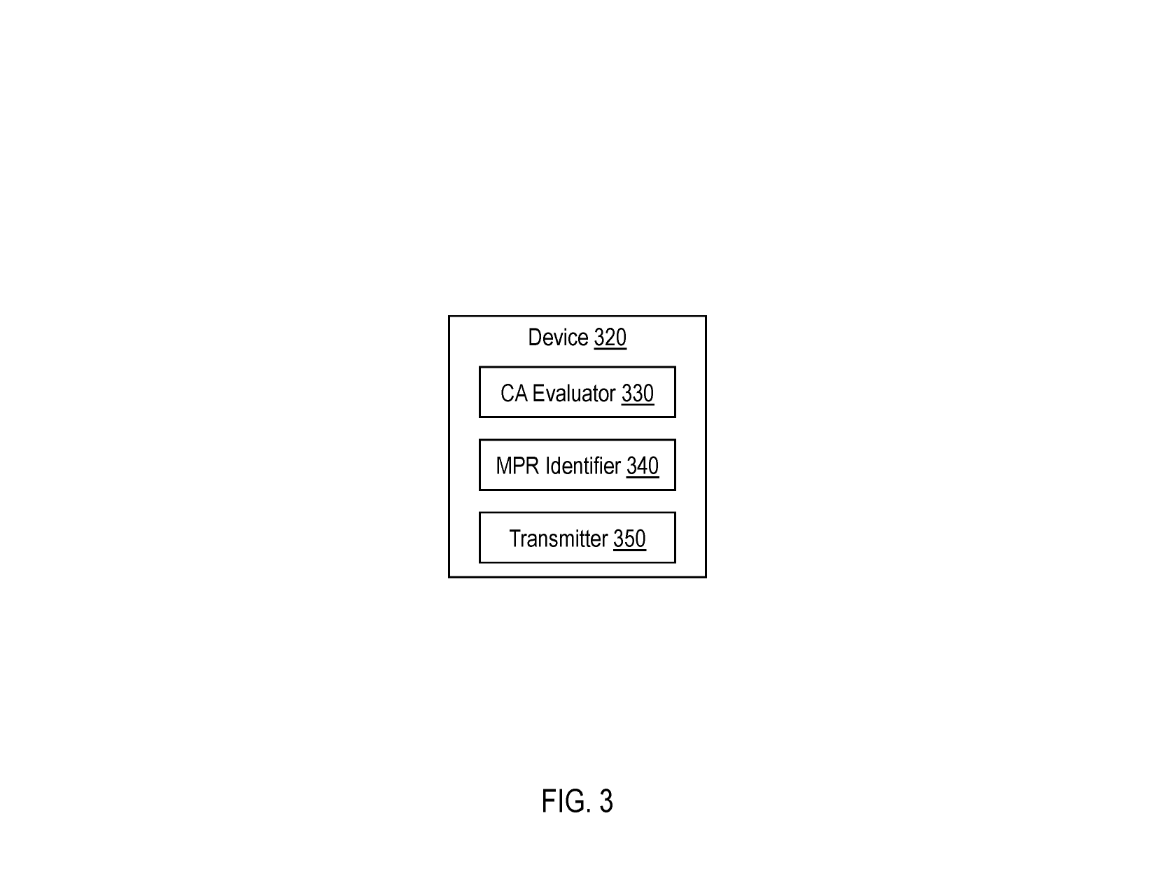

FIG. 3 is an example of a device 320 including a CA evaluator 330, an MPR identifier 340, and a transmitter 350, according to an example implementation of the present disclosure . In some embodiments, the device 320 may be or include a UE (e.g., the UE 120) such as a smartphone, a tablet, or other wireless communication devices. Each of the CA evaluator 330 and the MPR identifier 340 may include and/or be operated by one or more processors (e.g., the processor 224) configured to perform operations (e.g., signal processing, control logic, and power management for the device) as described herein. The transmitter 350 may be a wireless interface (e.g., the wireless interface 222). The transmitter 350 may be configured to send data via a wireless communication interface over a network (e.g., a cellular network). In particular, the transmitter 350 may perform intra-band CA, where two or more CCs allocated within the same frequency band are aggregated to increase the uplink throughput. In some implementations, the device 320 supports high-power uplink operation, such as Power Class 1.5, which allows for enhanced coverage and capacity in 5G New Radio (NR) systems. The CA evaluator 330, the MPR identifier 340, and the transmitter 350 may operate in conjunction to support such intra-band CA operation, including both contiguous and non-contiguous allocations across the aggregated carriers.

In some embodiments, the device 320 may be or include a UE (e.g., the UE 120), and the data may be transmitted to a base station (e.g., the base station 110). The base station may be a part of a radio access network that provides wireless connectivity between the UE and a core network (e.g., the core network 170). The transmitter of the UE may transmit various types of data, such as user traffic or control signaling, over an uplink connection established with the base station. The transmission may be carried out using one or more CCs aggregated through intra-band CA, and may be performed in accordance with the power class, MPR, and any additional constraints such as power-dependent MPR (P-MPR) and uplink duty cycle limitations, as determined by the processors.

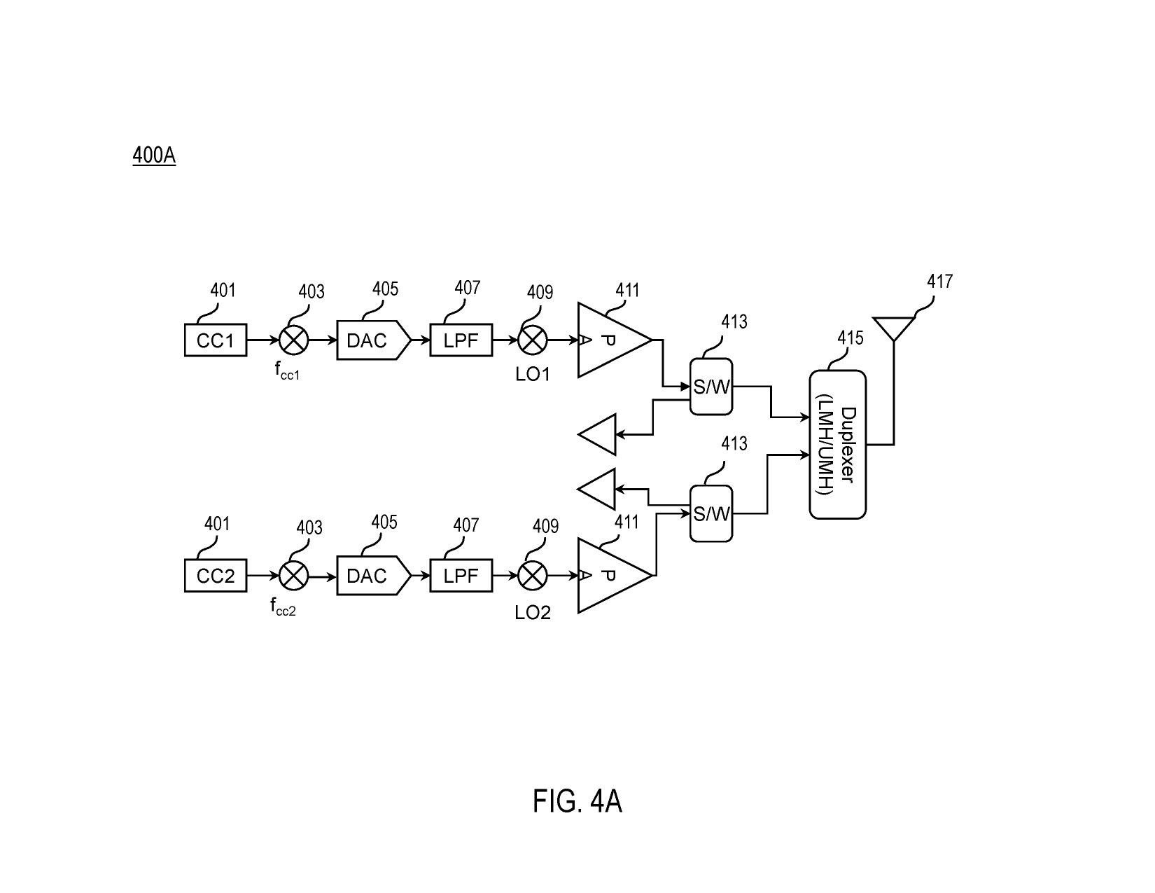

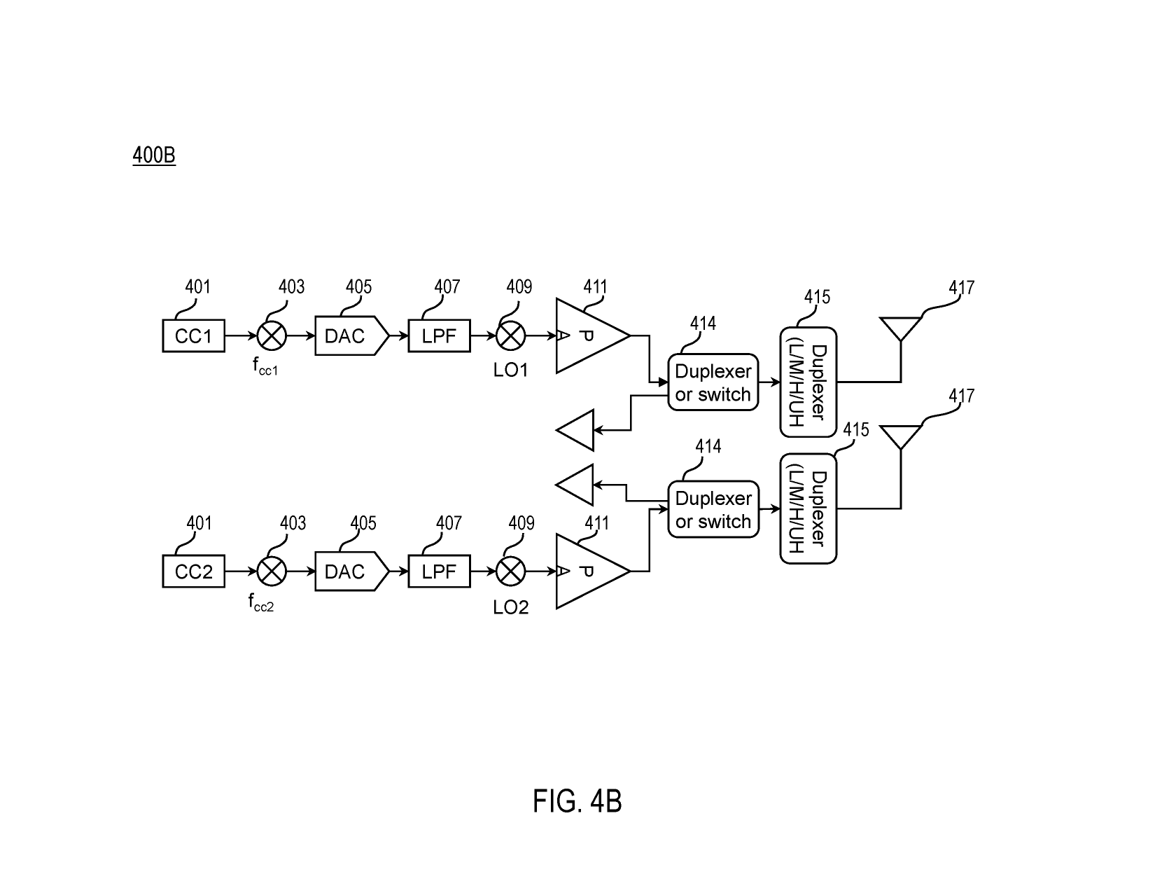

The device 320 may include various features (e.g., circuits, circuit components, signal paths, etc.) configured to dynamically determine MPR and operating the device 320 based thereon. FIG. 4A illustrates an example of a circuit 400A that can be included in the device 320, according to an example implementation of the present disclosure. For example, the circuit 400A may be included in the transmitter 350. The circuit 400A may include CCs (e.g., CC1, CC2) 401, first mixers 403, digital-to-analog converters (DACs) 405, low pass filters (LPFs) 407, second mixers 409, power amplifiers 411, switches 413, a duplexer 415, and an antenna 417. The circuit 400A may include more, fewer, or different components than shown in FIG. 4A.

In some embodiments, the CCs 401 may generate baseband signals (e.g., CC1, CC2) for respective uplink transmissions. The first mixers 403 may upconvert the baseband signals to respective intermediate frequencies using corresponding carrier frequencies (e.g., fcc1, fcc2). The DACs 405 may convert the mixed signals from digital to analog form. The LPFs 407 may filter out high-frequency noise components from the analog signals. The second mixers 409 may perform additional frequency conversion using respective local oscillators (e.g., LO1, LO2) to generate transmit signals at respective ratio frequencies. The power amplifiers 411 may amplify the transmit signals to the desired output power level (e.g., 26 dBm). The switches 413 may selectively route each transmit signal to the common duplexer 415. The duplexer 415 may isolate the transmit and receive paths while directing the transmit signals to the antenna 417 for wireless transmission.

The circuit 400A may be configured as an intra-band contiguous CA or DC UE RF architecture. In the circuit 400A, the aggregated CCs may reside within the same frequency band and can be processed through separate signal paths that ultimately converge at a shared transmission path. The use of a single antenna path, in conjunction with a common duplexer, may enable efficient RF front-end design while supporting high-power transmission (e.g., Power Class 1.5). This configuration can simplify antenna integration and reduce RF path duplication when operating in contiguous intra-band CA/DC scenarios.

FIG. 4B illustrates an example of a circuit 400B that can be included in the device 320, according to an example implementation of the present disclosure. For example, the circuit 400B may be included in the transmitter 350. The circuit 400B may be similar to or incorporate features of the circuit 400A, while alternatively including duplexers or switches 414, multiple duplexers 415, and multiple antennas 417. The circuit 400B may include more, fewer, or different components than shown in FIG. 4B.

In the circuit 400B, the duplexers or switches 414 may selectively route amplified signals from each transmit path toward a corresponding output path, enabling flexible control over signal flow in multi-band or spatially separated configurations. Unlike the single duplexer 415 used in the circuit 400A, the circuit 400B may include multiple duplexers 415 that provide independent filtering and transmit/receive isolation for each signal path. Additionally, the circuit 400B may include the multiple antennas 417, which can support simultaneous transmission across different bands or frequency-separated carriers, as in intra-band non-contiguous or inter-band CA/DC scenarios. This separation of RF front-end components may facilitate compliance with emission requirements and improve isolation when operating multiple high-power uplink paths concurrently.

Referring to FIG. 3, the CA evaluator 330 may be configured to determine, as a first determination result, whether the CA is contiguous or non-contiguous. In some implementations, the CA evaluator 330 may evaluate whether the aggregated CCs fall within a contiguous frequency range without any intervening gaps. If the CCs are positioned directly adjacent to one another within the same band, the CA may be considered contiguous. If the CCs are separated by one or more frequency gaps, the CA may be considered non-contiguous. This first determination result may serve as a basis for later operations, including identification of MPR values appropriate for the given CA configuration.

In some embodiments, the MPR identifier 340 may identify, based at least on a power class of the device 320 and the determination of whether the intra-band CA is contiguous or non-contiguous, an amount of MPR. The power class may reflect a transmit power capability of the device 320, such as Power Class 1.5, which can correspond to higher uplink transmission power levels. By identifying the power class in combination with the CA configuration, the MPR identifier 340 may determine an appropriate amount of MPR to reduce transmission power and meet system requirements, such as those related to signal linearity or emission control. The identified MPR value may be applied to one or more CCs associated with the aggregated uplink transmission. In this way, the MPR value may be selected to align with performance and regulatory limits based on the specific operating mode of the high-power UE.

In some embodiments, the power class of the device 320 may correspond to a maximum transmit power level selected from a set of defined values. For instance, the device 320 may operate according to Power Class 1.5, and the maximum transmit power of the device 320 may be one of 27.8 dBm, 29 dBm, 30 dBm, or 30.8 dBm. These power levels may be defined for different frequency ranges or regional emission requirements and may reflect support for high-power uplink operation in 5G New Radio (NR) systems. The MPR identifier 340 may identify this power class as part of the logic for determining applicable power control and emission compliance mechanisms, including the selection of a corresponding MPR value appropriate for the power class of the device 320.

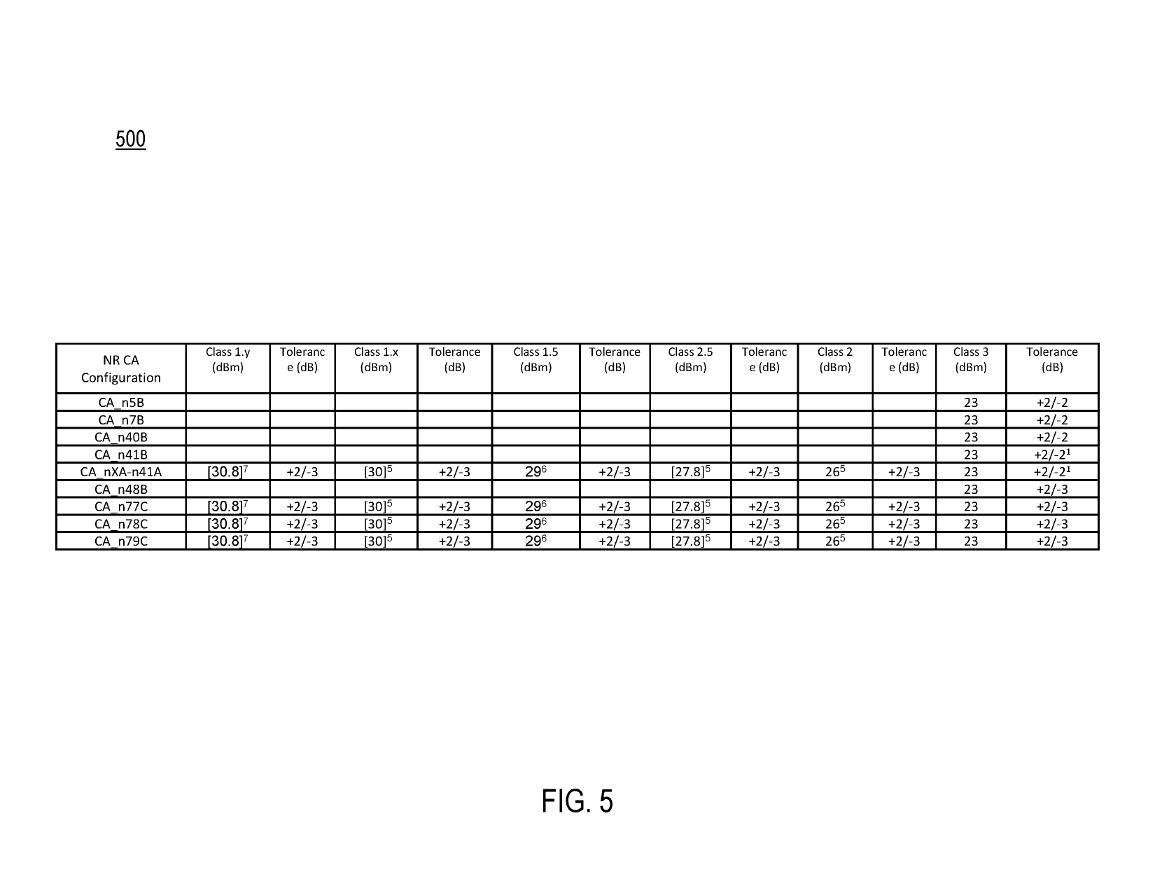

In some embodiments, the power class of the device 320 may correspond to a maximum transmit power level applicable to specific CA or DC scenarios. For example, FIG. 5 illustrates an example of different maximum transmit power values, according to an example implementation of the present disclosure. For example, Table 500 of FIG. 5 includes the different maximum transmit power values for UE operating under Power Class 1.5 across various inter-band CA or DC configurations. These configurations may include combinations such as CA_n78C or CA_n79C, where the maximum transmit power is defined as 30.8 dBm, 30 dBm, or 27.8 dBm, based on the applicable power class and frequency band. Table 500 further includes tolerances for each power class and indicates whether the device 320 supports the given class under time division duplex or frequency division duplex conditions. The MPR identifier 340 may use this power class information when determining transmission parameters and ensuring that the selected MPR value is appropriate for the relevant transmit power limits across the CCs.

In some embodiments, in identifying the amount of MPR of the device 320, the MPR identifier 340 may determine whether the transmitter uses contiguous RB allocation or non-contiguous RB allocation across the aggregated CCs. For instance, when the intra-band CA is determined to be contiguous, the RB allocation within the aggregated carriers may vary depending on how the frequency resources are assigned. The CA evaluator 330 may determine, as a second determination result, whether the RB allocation pattern is contiguous or non-contiguous. Based on the power class of the device 320 (e.g., Power Class 1.5), the first determination result (e.g., that the CA is contiguous), and the second determination result (e.g., the type of RB allocation), the MPR identifier 340 may identify a corresponding amount of MPR to be applied. The MPR may be selected form a predefined set of values corresponding to different power classes and RB allocation patterns and may be used to satisfy transmission requirements such as emission compliance, power efficiency, and link robustness under the given CA configuration.

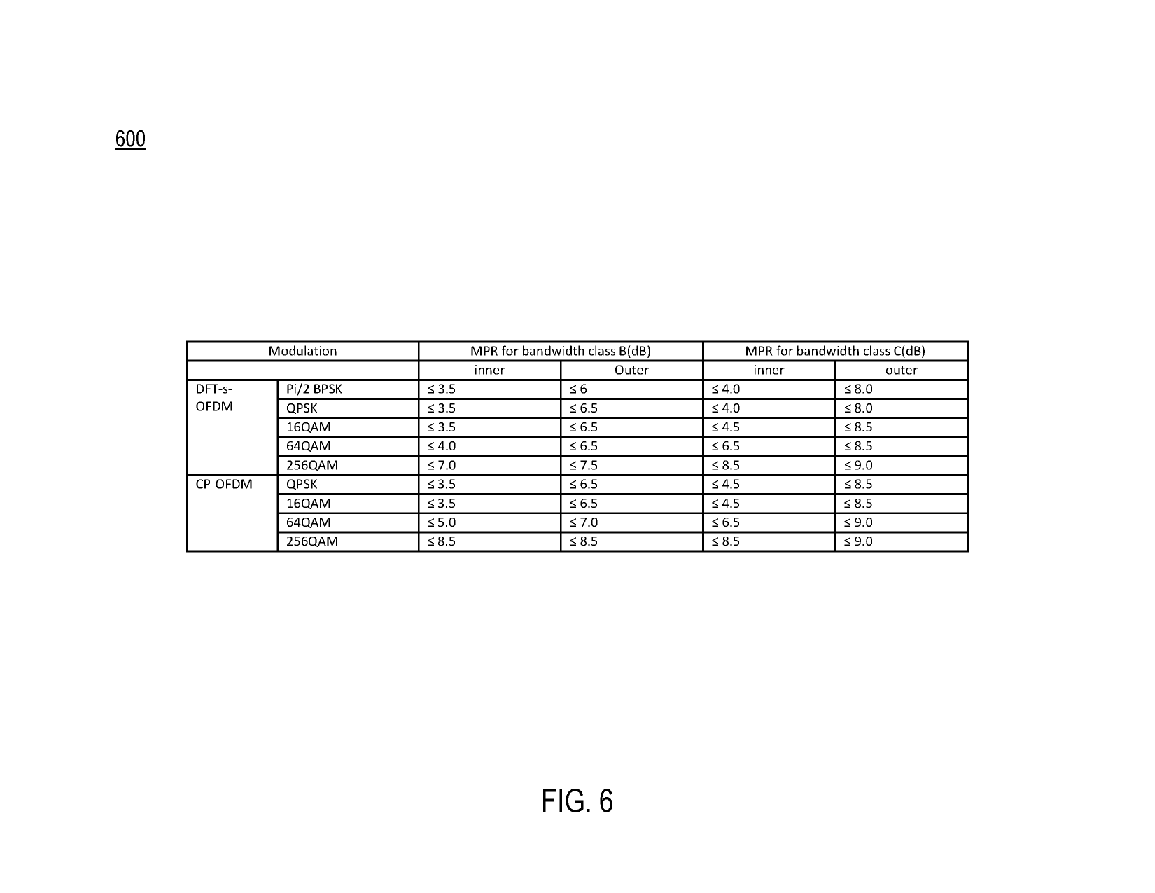

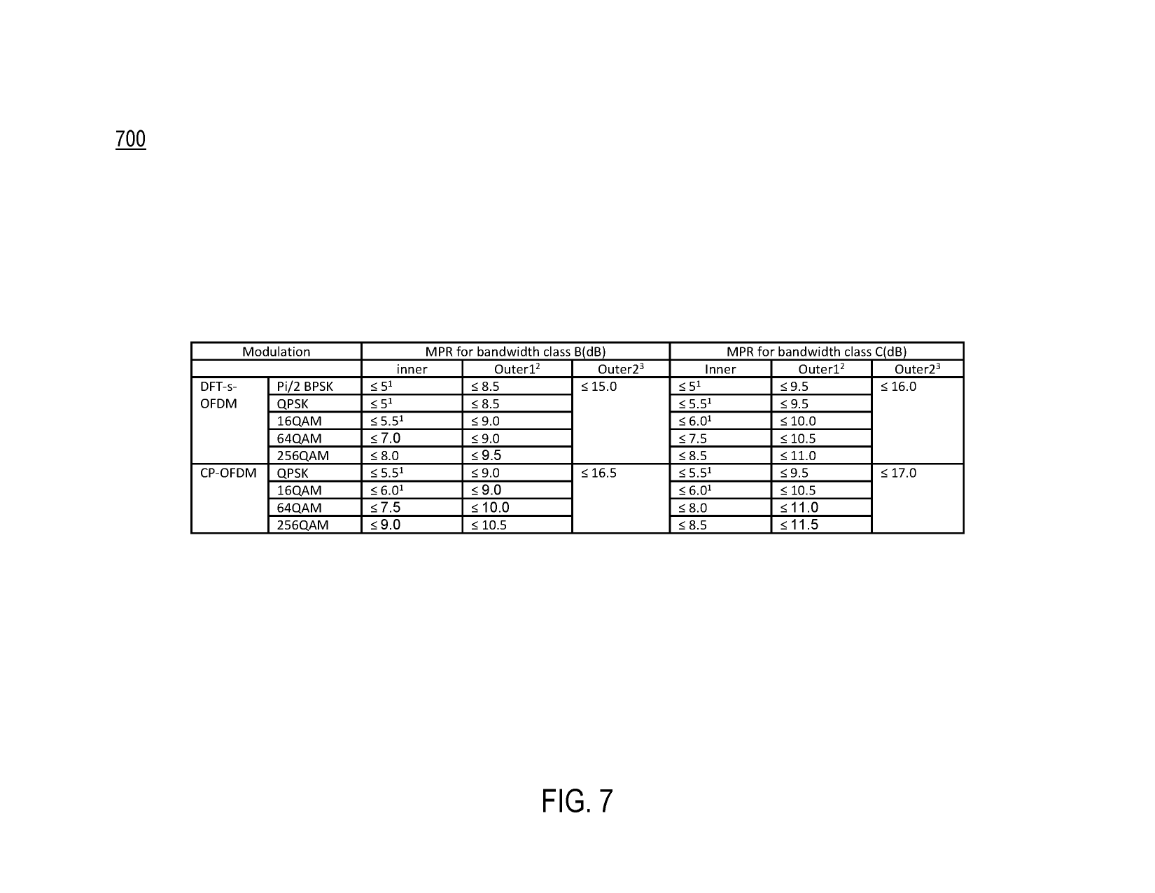

In some embodiments, the MPR identifier 340 may be configured to identify the amount of MPR based on the modulation scheme and the bandwidth class of the aggregated uplink transmission, particularly when the RB allocation is contiguous. For instance, the MPR identifier 340 may reference a mapping of MPR values based on combinations of modulation type (e.g., Pi/2 Binary Phase Shift Keying (BPSK), Quadrature Phase Shift Keying (QPSK), 16 Quadrature Amplitude Modulation (16QAM), 64QAM, 256QAM) and transmission format (e.g., Discrete Fourier Transform-spread Orthogonal Frequency Division Multiplexing (DFT-s-OFDM), Cycle Prefix-OFDM (CP-OFDM)) across defined bandwidth classes (e.g., class B and class C). FIG. 6 illustrates an example of MPR values, according to an example implementation of the present disclosure. More specifically, Table 600 of FIG. 6 defines inner and outer MPR constraints for each modulation and waveform pairing for contiguous RB allocations in intra-band contiguous CA. Based on the determined modulation, waveform, and bandwidth class, along with the RB allocation pattern and power class (e.g., Power Class 1.5), the MPR identifier 340 may identify a specific MPR value from Table 600. This identified MPR may help ensure that the device 320 operates within spectral emission limits and achieves reliable performance across different contiguous CA configurations using dual transmit chains. FIG. 7 illustrates an example of MPR values, according to an example implementation of the present disclosure. More specifically, Table 700 of FIG. 7 defines inner and outer MPR constraints for each modulation and waveform pairing for non-contiguous RB allocations in intra-band contiguous CA.

In some embodiments, in identifying the amount of MPR of the device 320, the MPR identifier 340 may identify the MPR based at least on a power class of the device 320, a first determination result, and an OOB emission limit. For instance, when the first determination result indicates that the intra-band CA is non-contiguous, the CA evaluator 330 may evaluate the spectral behavior of the aggregated uplink transmission. In particular, the CA evaluator 330 may consider how emissions fall outside the assigned frequency band (e.g., OOB emissions). The device 320 may reference a regulatory or system-defined OOB emission limit that is not to be exceeded. Based on this emission constraint, along with the power class of the device 320 (e.g., Power Class 1.5 or others) and the determination that the CA is non-contiguous, the MPR identifier 340 may select an appropriate MPR value that ensures compliance with the emission requirement. This identified MPR value may then be applied to limit the transmit power so that the emissions remain within allowed spectral boundaries.

In some embodiments, the OOB emission limit may be defined according to specific transmit spectral mask requirements for high-power uplink devices using intra-band non-contiguous CA with a dual power amplifier architecture. For example, the MPR identifier 340 may determine that the applicable OOB emission limit is –30 dBm/MHz and may identify a corresponding amount of MPR to ensure compliance with this limit. The MPR identifier 340 may determine that the MPR is equal to a value selected based on the total occupied bandwidth (B) of the aggregated uplink carriers. For example, the value may be 17.0 dB when B is less than 1.44 MHz, 16.0 dB when B is between 1.44 MHz and 2.88 MHz, 14.5 dB when B is between 2.88 MHz and 5.76 MHz, 13.0 dB when B is between 5.76 MHz and 10.8 MHz, 11.5 dB when B is between 10.8 MHz and 23.04 MHz, 10.0 dB when B exceeds 23.04 MHz, etc. In another example, for a different emission limit, such as –13 dBm/MHz (e.g., for spurious emission scenarios), the MPR identifier 340 may determine the MPR using an alternate MA profile, such as 10.5 dB when B is less than 0.54 MHz, 9.5 dB when B is between 0.54 MHz and 1.08 MHz, 8.0 dB when B is between 1.08 MHz and 2.16 MHz, 7.5 dB when B is between 2.16 MHz and 5.4 MHz, 6.5 dB when B is between 5.4 MHz and 10.8 MHz, 5.0 dB when B exceeds 10.8 MHz, etc. In each case, the MPR identifier 340 may select the MPR value based on the bandwidth category, the applicable emission constraint, and the power class of the device 320, ensuring that transmission complies with emission limits under the given CA configuration.

In some embodiments, in identifying the amount of MPR of the device 320, the MPR identifier 340 may identify the MPR based at least on a power class of the device 320, a first determination result, and a spurious emission limit. For instance, when the first determination result indicates that the intra-band CA is non-contiguous, the MPR identifier 340 may assess whether the uplink transmission produces unwanted emissions that fall outside the expected frequency bands but are not within the regulated OOB ranges (e.g., spurious emissions). In such cases, the MPR identifier 340 may reference a spurious emission limit specified by regulatory guidelines or system requirements. The MPR identifier 340 may then identify an MPR value that is sufficient to ensure that the transmission power remains within the allowed spurious emission thresholds. This MPR value may be determined based on the combination of the applicable power class (e.g., Power Class 1.5), the non-contiguous CA determination, and the relevant spurious emission limit.

In some embodiments, the transmitter may be configured to transmit data using the identified amount of MPR of the device 320. For example, based on the MPR value identified by MPR identifier 340, taking into account parameters such as power class, component CA configuration, and emission limits, the transmitter may reduce its output power accordingly. This adjustment can help ensure that the transmitted signal adheres to regulatory limits for emissions (e.g., OOB or spurious) while maintaining reliable uplink communication. The transmitter may apply this power setting when sending uplink data to a base station or other receiving device as part of normal operation in a wireless communication system.

In some embodiments, the MPR identifier 340 may identify a SAR limit applicable to the device 320 . The SAR limit may represent a regulatory or design constraint on the amount of radio frequency (RF) energy absorbed by the user’s body during operation. Based on the identified SAR limit and the previously identified amount of MPR, the MPR identifier 340 may determine an amount of P-MPR of the device 320 . The P-MPR may reflect an additional reduction in transmit power needed to ensure that the device 320 remains compliant with SAR requirements under varying operating conditions. The transmitter may transmit second data using the determined amount of P-MPR, thereby maintaining both emission compliance and user exposure limits during uplink transmissions.

In some embodiments, the MPR identifier 340 may identify a maximum uplink duty cycle of the device 320 based at least on the power class of the device 320 . The maximum uplink duty cycle may correspond to a regulatory or implementation-defined limit on how frequently the device 320 is permitted to transmit data within a given time interval. The MPR identifier 340 may also identify a SAR limit and determine, based on both the SAR limit and the identified maximum uplink duty cycle, an adjusted maximum uplink duty cycle of the device 320 . The adjusted value may ensure that the average transmit power over time satisfies SAR compliance under high-power operating conditions. The transmitter may be configured to transmit third data using the amount of P-MPR, the adjusted maximum uplink duty cycle, or a combination of the P-MPR and the adjusted maximum uplink duty cycle. This approach may enable adaptive transmission control while maintaining conformance with emission exposure limits.

In some embodiments, the MPR identifier 340 may determine that a maximum uplink duty cycle of the device 320 does not meet a SAR limit. For instance, under certain transmission scenarios, such as prolonged high-power uplink operation, the cumulative uplink activity may exceed the allowed SAR exposure threshold. In response, the transmitter may be configured to transmit, to a base station, an indication of the amount of P-MPR of the device 320 . This indication may allow the base station to coordinate or adjust network-side parameters accordingly, such as scheduling or power control, to maintain compliance with SAR constraints while sustaining communication performance.

In some embodiments, the device 320 may perform a DC operation. In such an operation, the device 320 may establish and maintain simultaneous connections with two distinct base stations or network nodes, such as a master node and a secondary node. These nodes may operate on different carrier frequencies or in different frequency bands. The DC operation can improve throughput, reduce latency, and enhance reliability by enabling data transmission and reception over both connections. The MPR identifier 340 may control coordination of data flow across the master and secondary links, while the transmitter may support scheduling, resource allocation, and power management for both links in accordance with the CA configuration and the applicable power class.

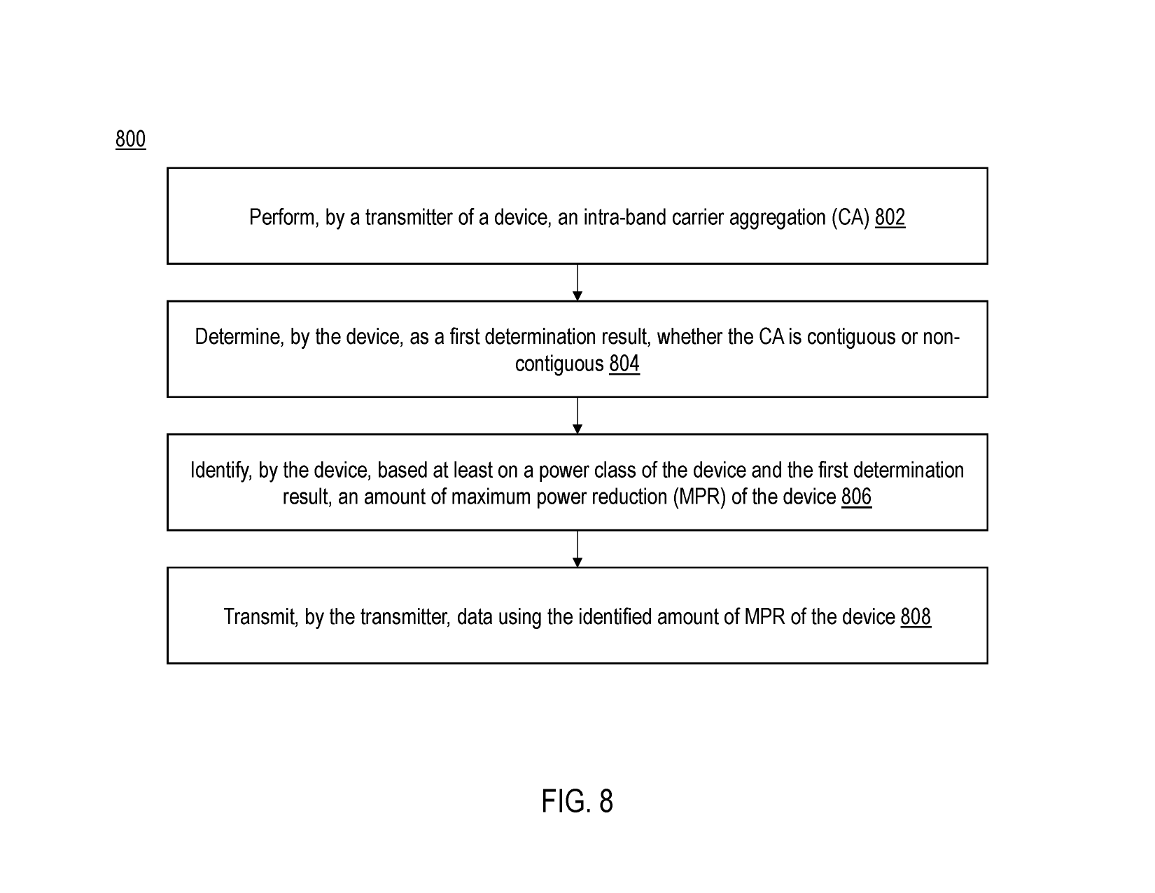

FIG. 8 is a flowchart showing a process 800 for MPR, according to an example implementation of the present disclosure. In some embodiments, the process 800 is performed by a device (e.g., the device 320, the UE 120, or otherwise any device configured to perform an intra-band CA) including one or more processors (e.g., processors 224) and a transmitter (e.g., the transmitter 350, the wireless interface 222). In some embodiments, the process 800 may be performed by a device configured to perform a DC operation. In some embodiments, the process 800 may be performed by a UE configured to transmit data to a base station. In some embodiments, the process 800 is performed by other entities. In some embodiments, the process 800 includes more, fewer, or different steps than shown in FIG. 8.

In some embodiments, the one or more processors of a device (e.g., the device 320, the UE 120) may determine, as a first determination result, whether the CA is contiguous or non-contiguous. In some embodiments, the one or more processors of the device may identify an amount of MPR. For example, the one or more processors of the device may identify the amount of MPR based at least on a power class (e.g., Power Class 1.5).

In some embodiments, the power class of the device may correspond to a maximum transmit power of one of 27.8 dBm, 29.0 dBm, 30.0 dBm, or 30.8 dBm. In some embodiments, in which the first determination is that the CA is contiguous, the one or more processors may determine, as a second determination result, whether the transmitter uses contiguous RB allocation or non-contiguous RB allocation. The one or more processors may identify, based at least on the power class of the device, the first determination result and the second determination result, the amount of MPR of the device.

In some embodiments, in which the first determination is that the CA is non-contiguous, the one or more processors may identify, based at least on the power class of the device, the first determination result, and an OOB emission limit, the amount of MPR of the device. In some embodiments, in which the first determination is that the CA is non-contiguous, the one or more processors may identify, based at least on the power class of the device, the first determination result, and a spurious emission limit, the amount of MPR of the device.

In some embodiments, the transmitter of the device may be configured to transmit data using the identified amount of MPR of the device. In some embodiments, the one or more processors may identify a SAR limit. The one or more processors may determine, based at least on the SAR limit and the amount of MPR of the device, an amount of power-dependent MPR (P-MPR) of the device. The transmitter may be configured to transmit second data using the amount of P-MPR of the device. In some embodiments, the one or more processors may identify, based at least on the power class of the device, a maximum uplink duty cycle of the device. The one or more processors may determine, using the SAR limit and the maximum uplink duty cycle, an adjusted maximum uplink duty cycle of the device. The transmitter may be configured to transmit third data using the amount of P-MPR of the device, the adjusted maximum uplink duty cycle, or a combination of the amount of P-MPR of the device and the adjusted maximum uplink duty cycle. In some embodiments, the one or more processors may determine that the maximum uplink duty cycle of the device does not meet the SAR limit. The transmitter may be configured to transmit, to a base station, the amount of P-MPR of the device.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/-10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A device, comprising:
one or more processors and a transmitter that performs an intra-band carrier aggregation (CA), wherein:
the one or more processors are configured to:
determine, as a first determination result, whether the CA is contiguous or non-contiguous; and
identify, based at least on a power class of the device and the first determination result, an amount of maximum power reduction (MPR) of the device, and
the transmitter is configured to transmit data using the identified amount of MPR of the device.

2. The device of claim 1, wherein the power class of the device corresponds to a maximum transmit power of one of 27.8dBm, 29dBm, 30dBm, or 30.8dBm.

3. The device of claim 1, wherein the device performs a dual connectivity (DC) operation.

4. The device of claim 1, wherein
the device is a user equipment (UE), and
the data is transmitted to a base station.

5. The device of claim 1, wherein in identifying the amount of MPR of the device, the one or more processors are configured to:
determine, as a second determination result, whether the transmitter uses continuous resource block (RB) allocation or non-contiguous RB allocation; and
identify, based at least on the power class of the device, the first determination result and the second determination result, the amount of MPR of the device,
wherein the first determination is that the CA is contiguous.

6. The device of claim 1, wherein in identifying the amount of MPR of the device, the one or more processors are configured to:
identify, based at least on the power class of the device, the first determination result, and an out-of-band (OOB) emission limit, the amount of MPR of the device,
wherein the first determination is that the CA is non-contiguous.

7. The device of claim 1, wherein in identifying the amount of MPR of the device, the one or more processors are configured to:
identify, based at least on the power class of the device, the first determination result, and a spurious emission limit, the amount of MPR of the device,
wherein the first determination is that the CA is non-contiguous.

8. The device of claim 1, wherein
the one or more processors are further configured to:
identify a specific absorption rate (SAR) limit; and
determine, based at least on the SAR limit and the amount of MPR of the device, an amount of power-dependent maximum power reduction (P-MPR) of the device, and
the transmitter is configured to transmit second data using the amount of P-MPR of the device.

9. The device of claim 8, wherein
the one or more processors are configured to:
identify, based at least on the power class of the device, a maximum uplink duty cycle of the device; and
determine, using the SAR limit and the maximum uplink duty cycle, an adjusted maximum uplink duty cycle of the device, and
the transmitter is configured to transmit third data using the amount of P-MPR of the device, the adjusted maximum uplink duty cycle, or a combination of the amount of P-MPR of the device and the adjusted maximum uplink duty cycle.

10. The device of claim 8, wherein
the one or more processors are configured to determine that a maximum uplink duty cycle of the device does not meet the SAR limit, and
the transmitter is configured to transmit, to a base station, the amount of P-MPR of the device.

11. A method, comprising:
performing, by a transmitter of a device, an intra-band carrier aggregation (CA);
determining, by one or more processors of the device, as a first determination result, whether the CA is contiguous or non-contiguous;
identifying, by the one or more processors, based at least on a power class of the device and the first determination result, an amount of maximum power reduction (MPR) of the device; and
transmitting, by the transmitter, data using the identified amount of MPR of the device.

12. The method of claim 11, wherein the power class of the device corresponds to a maximum transmit power of one of 27.8dBm, 29dBm, 30dBm, or 30.8dBm.

13. The method of claim 11, further comprising:
performing, by the device, a dual connectivity (DC) operation.

14. The method of claim 11, wherein
the device is a user equipment (UE), and
the data is transmitted to a base station.

15. The method of claim 11, wherein identifying the amount of MPR of the device comprises:
determining, as a second determination result, whether the transmitter uses continuous resource block (RB) allocation or non-contiguous RB allocation; and
identifying, based at least on the power class of the device, the first determination result and the second determination result, the amount of MPR of the device,
wherein the first determination is that the CA is contiguous.

16. The method of claim 11, wherein identifying the amount of MPR of the device comprises:
identifying, based at least on the power class of the device, the first determination result, and an out-of-band (OOB) emission limit, the amount of MPR of the device,
wherein the first determination is that the CA is non-contiguous.

17. The method of claim 11, wherein identifying the amount of MPR of the device comprises:
identifying, based at least on the power class of the device, the first determination result, and a spurious emission limit, the amount of MPR of the device,
wherein the first determination is that the CA is non-contiguous.

18. The method of claim 11, further comprising:
identifying a specific absorption rate (SAR) limit;
determining, based at least on the SAR limit and the amount of MPR of the device, an amount of power-dependent maximum power reduction (P-MPR) of the device; and
transmitting, by the transmitter, second data using the amount of P-MPR of the device.

19. The method of claim 18, further comprising:
identifying, based at least on the power class of the device, a maximum uplink duty cycle of the device;
determining, using the SAR limit and the maximum uplink duty cycle, an adjusted maximum uplink duty cycle of the device; and
transmitting, by the transmitter, third data using the amount of P-MPR of the device, the adjusted maximum uplink duty cycle, or a combination of the amount of P-MPR of the device and the adjusted maximum uplink duty cycle.

20. The method of claim 18, further comprising:
determining that a maximum uplink duty cycle of the device does not meet the SAR limit; and
transmitting, by the transmitter to a base station, the amount of P-MPR of the device.
